(19) United States
(12) Patent Application Publication
(10) Pub. No.: US 2009/0260658 A1
(43) Pub. Date: Oct. 22, 2009

(54) TOILET BOWL CLEANING APPARATUS AND METHODS

(76) Inventors: Haruo Miyagi, Lehi, UT (US); Yoshi Miyagi, Lehi, UT (US); Haruyoshi Miyagi, Lehi, UT (US); Daniel J. Rodrigue, Draper, UT (US); Mark E. Schulte, Provo, UT (US)

Correspondence Address: ALAN J. HOWARTH, P.O. BOX 1909, SANDY, UT, 84091-1909, US

(21) Appl. No.: 12/391,158

(22) Filed: Feb. 23, 2009

Related U.S. Application Data
(60) Provisional application No. 61/030,961, filed on Feb. 23, 2008.

(51) Int. Cl. B08B 9/00; E03D 9/02

(52) U.S. Cl. 134/22.1; 4/231

(57) ABSTRACT

A toilet bowl cleaning unit disposed to intercept an intermittent flow of water from each flush of the water from a water line to a toilet bowl comprising a mounting device for installation in the flow of water, and a water-soluble compound positioned on the mounting device to intercept a substantial portion of the water as it is flushed from the water line to the toilet bowl, said water-soluble compound thereby being released into the toiled bowl with the water from each flush to inhibit formation of mineral deposits on the surfaces of the toilet bowl and/or drainage pipes. A method for cleaning a toilet bowl, comprising providing an intermittent flow of water from a water line to a toilet bowl with each flush of the toilet bowl, and providing a water-soluble compound to intercept a substantial portion of the flow of water, said water-soluble compound thereby being released into the toilet bowl with the water from each flush to inhibit formation of mineral deposits on the surfaces of the toilet bowl and/or drainage pipes.

### CROSS-REFERENCE TO RELATED APPLICATION

This application claims the benefit of U.S. Provisional Application No. 61/030,961, filed Feb. 23, 2008, which is hereby incorporated by referenced herein in it entirety, including but not limited to, those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

N/A.

### BACKGROUND OF THE INVENTION

1. Field of the Invention

This invention relates to toilet bowl cleaning apparatus and methods, and more particularly, to an apparatus mountable within a toilet bowl and methods that clean deposits in toilet bowls with each flush of the toilet.

2. Description of the Prior Art

Potassium phosphate is formed by the reaction of potassium, phosphoric acid and carbon dioxide. Since urine and fecal matter typically contain all three compounds, it is common for calculus deposits to be formed in toilets and toilet drain pipes containing a combination of potassium phosphate and organic compounds eliminated by the body. As the organic compounds decay, the calculus deposits give off a characteristic foul odor that is present in poorly maintained rest rooms. Because urine and fecal calculus deposits do not readily dissolve in water, their removal is a challenge for janitorial staffs.

After calcium, potassium and phosphorus are the most abundant elements found in the human body. Calcium, potassium and phosphorus are, respectively, the first, second and third most common elements found in the human body. The presence of potassium is essential for the regulation of the acid-base balance and water balance in the blood and the body tissues, for the synthesis of proteins from amino acids, for carbohydrate metabolism, for the building of muscle tissue, for normal body growth, and for the proper functioning of nerve cells, in the brain and throughout the body. With the proliferation of soft drinks, such as colas, which contain both phosphoric acid and carbon dioxide, these two ingredients are found in urine and fecal matter in increasing concentrations.

In order to counteract the foul odor of decomposing urine and fecal matter, deodorant blocks are commonly placed inside toilets and urinals. For many years, deodorant blocks containing paradichlorobenzene and/or naphthalene were used to counteract odors in rest rooms. However, during the last several decades, it has been observed that exposure to the former chemical is responsible for numerous health problems, including kidney and liver disease. Consequently, the use of paradichlorobenzene—particularly around children—has been prohibited in certain jurisdictions. Naphthalene has compiled a record of even greater toxicity than paradichlorobenzene. Other, less toxic aromatic compounds are now being used to combat foul odors in rest rooms.

One current device involves the use of drop tabs in a toilet tank. Unfortunately, all cleaning chemicals in the tabs quickly dissipate in the water and are flushed down the drain, so there is little, if any, long term cleaning effect. Another device used for toilet bowl cleaning clips over the side of the bowl so that a small amount of the water released into the bowl runs over the cleaning compound. This device is only marginally effective because of very limited contact with the bowl water. Another device connects to the back of the toilet bowl by suction. Again, there is limited contact with the water released into the bowl for cleaning.

What is needed is an apparatus that is installable within the toilet bowl in a position to come into contact with substantially all of the fresh water released into the bowl. Further, what is needed is a device that releases a water-soluble compound into substantially all of the fresh water coming into a toilet bowl so as to effectively clean the bowl. Also needed is a device to not only release a refreshing aroma that counteracts urine and fecal matter odors, but also dispense a controlled amount of chemical compound that interferes with the formation of urine and fecal matter calculus deposits in toilet bowls and toilet drain pipes.

### SUMMARY OF THE INVENTION

A toilet bowl cleaning unit disposed to intercept an intermittent flow of water from each flush of water from a water line to a toilet bowl comprises a mounting device for installation in the flow of water, and a water-soluble compound positioned on the mounting device to intercept a substantial portion of the water as it is flushed from the water line to the toilet bowl, said water-soluble compound thereby being released into the toiled bowl with the water from each flush to inhibit formation of mineral deposits on the surfaces of the toilet bowl and/or drainage pipes.

A method for cleaning a toilet bowl comprises providing an intermittent flow of water from a water line to a toilet bowl with each flush of the toilet bowl, and providing a water-soluble compound to intercept a substantial portion of the flow of water, said water-soluble compound thereby being released into the toilet bowl with the water from each flush to inhibit formation of mineral deposits on the surfaces of the toilet bowl and/or drainage pipes.

### BRIEF DESCRIPTION OF THE DRAWINGS

FIG. 1 is an isometric front side view of the toilet bowl cleaner unit that installs under the rim of a toilet bowl;

FIG. 2 is an isometric back side view of the toilet bowl cleaner unit;

FIG. 3 is a close-up isometric view of one of the six grills that houses one or more bleach packets;

FIG. 4 is a close-up isometric view of the joint structure at the center of the toilet bowl cleaner unit; and

FIG. 5 is a side elevational view of a polymer cloth packet containing a bleach in solid granular form;

FIG. 6 is an end view of the polymer cloth packet of FIG. 5;

FIG. 7 is an isometric view of a block of bleach in solid block form, the block shaped to fit behind a grill cover; and

FIG. 8 is a cross-sectional side view of a toilet having an elongated bowl in which the toilet bowl cleaner unit has been installed.

### DETAILED DESCRIPTION OF THE INVENTION

The present invention relates to a toilet bowl cleaner unit that intercepts the flow of water into a toilet bowl with each flush to provide a water soluble cleaning agent for cleaning the toilet bowl.

In one illustrative embodiment, a cleaner unit is provided that installs under the rim of a toilet bowl. The unit includes a generally linear, resilient mounting strip having a front side and a back side, which can bent into a horseshoe shape for installation beneath the rim of a toilet bowl. When the mounting strip is bent to conform to the shape of the toilet bowl, energy is stored in the mounting strip. This stored energy confers a “memory” to the mounting strip, which attempts to return the mounting strip to its original linear conformation. The stored energy exerts a radial force against the toilet bowl that holds the mounting strip in place within the toilet bowl in the horseshoe configuration.

The memory of the plastic hoop may be enhanced by incorporating structural fibers in the plastic. Structural fibers can be made of glass, graphite, boron nitride, boron carbide, and other similar materials that have excellent memory characteristics up to the point of fracture. As a practical matter, glass fibers are the most common and least expensive structural fibers available. In addition, they can be made transparent. Thus, if it is desired that the mounting strip match the color of a white toilet bowl, transparent glass fibers in a resilient polymer plastic containing titanium dioxide pigment is likely the most cost effective combination. Multiple supply modules snap onto the resilient mounting strip and contain a water-soluble compound for removing urine and fecal matter deposits from the toilet bowl.

In a first illustrative embodiment, a bleach supply module includes one or more grill covers that snap onto the resilient mounting strip, each grill cover containing at least one water-permeable polymer cloth package containing bleach granules. The polymer cloth is made from mildew resistant fibers made from a polymer such as nylon, polypropylene, polyethylene, or other similar polymers, which are equivalent for the application.

The bleach also works as a deodorant, since the foul smelling deposits are removed and a smell of chlorine and/or other cleaning chemicals is predominant. Optionally, the bleach compound may include a fragrance to further deodorize and provide a pleasing smell. Further, the mounting strip might optionally include a deodorant bar incorporating a sublimable aromatic material suspended on a resilient clip, which is unitary with the mounting strip and projects from the back side thereof. As the resilient clip is longer than the bar is thick, it acts as a standoff to space the deodorant bar away from the side of the toilet bowl so that a greater surface area of the deodorant bar is exposed to air in the toilet bowl. The deodorant bar continually dispenses an odor-counteracting aroma.

With each flush of the toilet, the bleach granules within the cloth packets are partially dissolved, thereby dispensing a controlled amount of the chemical compound, which interferes with the formation of urine and fecal matter calculus deposits that form within the toilet bowl. The bleach granules and deodorant bar are designed to last for generally about 30 to 90 days, depending on the amount of usage. At the end of this period, the unit is removed, discarded, and replaced with a fresh unit.

The mounting strip may incorporate a hook and loop at opposite ends thereof so that the entire cleaner unit having expended the bleach supplies and, optionally the deodorant supplies, may be discarded as a hoop that fits within canister-type garbage containers. As a means of reducing manufacturing cost of the item, the hoop may be made in two equal-length pieces, which lock together to form a single linear piece. The mounting strip may incorporate a gentle curve along its length so that when it is bent into a horseshoe configuration, the lower edge of the mounting strip is angled slightly toward the toilet bowl, thereby making the installation thereof less conspicuous.

The invention will now be described with reference to the included drawing figures. It is to be understood that the drawings are not necessarily drawn to scale, and that they are intended to be merely illustrative.

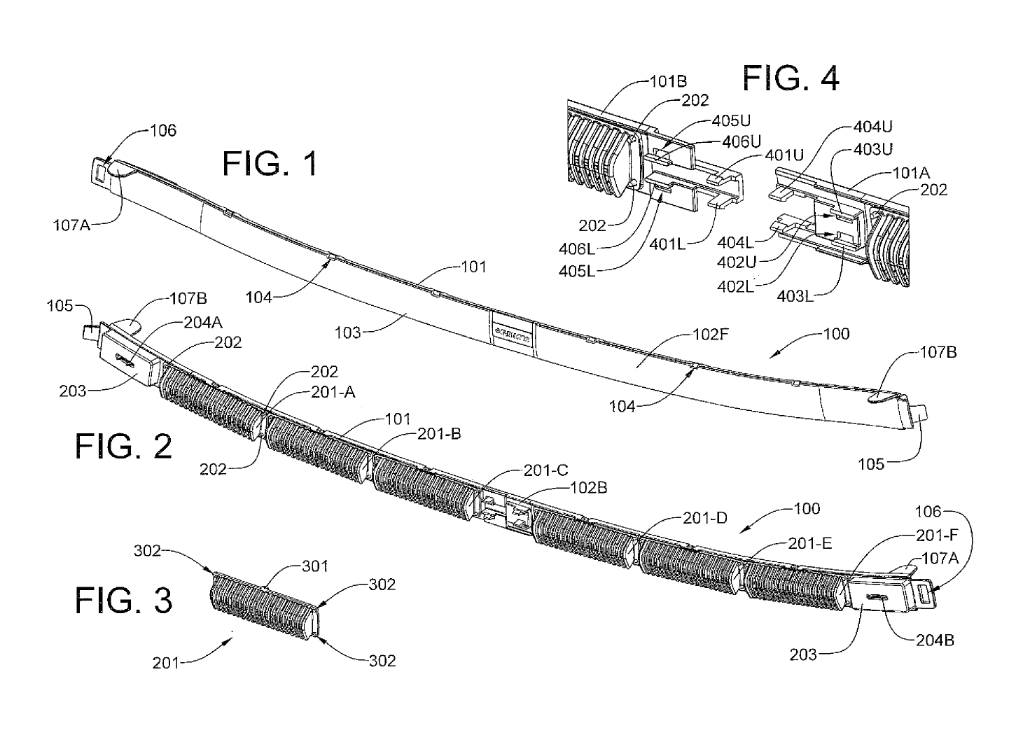

Referring now to FIGS. 1 and 2, the cleaner unit 100 includes a generally linear, resilient mounting strip 101 having a front side 102F and a back side 102B, which can be bent into a horseshoe shape for installation beneath the rim of a toilet bowl. When the mounting strip 101, which may be made of injection-molded polymer plastic, is bent to conform to the shape of the toilet bowl, energy is stored in the mounting strip 101. This stored energy, which is provided by the stretching of molecular bonds and attractions, confers a “memory” to the mounting strip which attempts to return the mounting strip 101 to its original linear conformation. The stored energy exerts a radial force against the toilet bowl that holds the mounting strip 101 in place within the toilet bowl in the horseshoe configuration.

As polymer plastic compounds typically tend to flow under pressure and stress at a rate that is a function of temperature, the memory of the resilient mounting strip may be made more permanent by incorporating structural fibers in the polymer plastic to form a composite matrix. Structural fibers can be made of glass, graphite, boron nitride, boron carbide, and other similar materials, which have excellent memory characteristics up to the point of fracture. As a practical matter, glass fibers are the most common and least expensive structural fibers available. In addition, they can be made transparent. Thus, if it is desired that the mounting strip match the color of a white toilet bowl, transparent glass fibers in a resilient polymer plastic containing titanium dioxide pigment is likely the most cost effective combination. The mounting strip 101 may incorporate a gentle curve along its length so that when it is bent into a horseshoe configuration, the lower edge 103 of the mounting strip 101 is angled slightly toward the toilet bowl, thereby making the installation thereof less conspicuous.

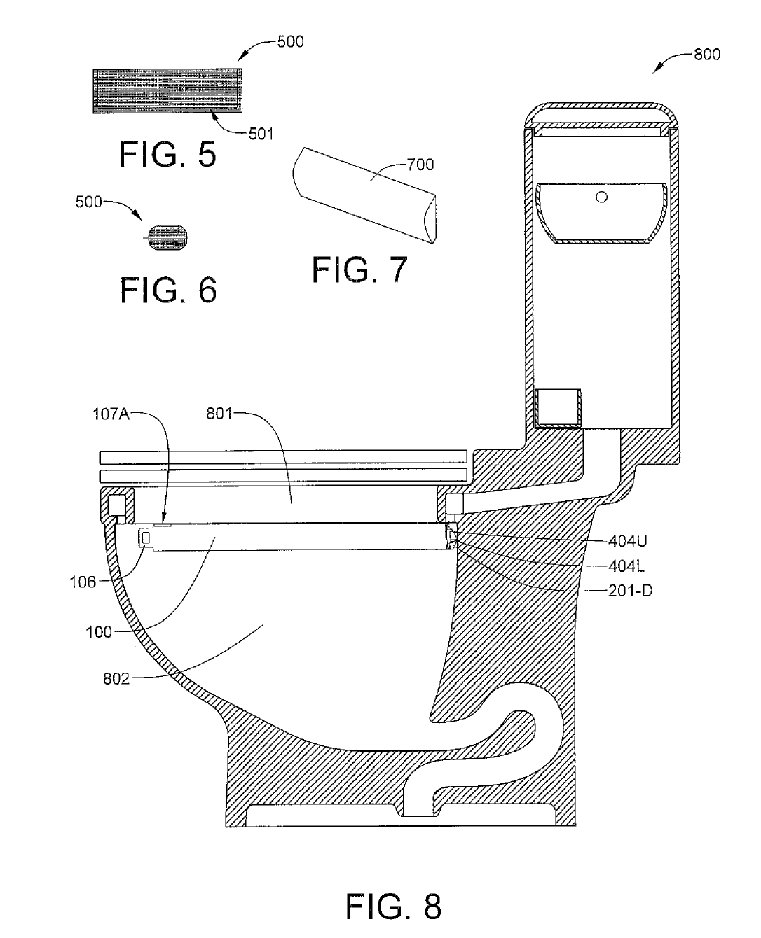

Referring now to FIGS. 1, 2, and 3 multiple grill covers 201-A, 201-B, 201-C, 201-D, 201-E and 201-F (201, generally) snap onto the resilient mounting strip 101. Each grill cover 201 holds a supply of a bleach in either granular or block form. Some types of bleach that are effective for this application are, without limitation, hydrogen peroxide (H₂O₂), TCIC (trichloroisocyanuric acid), SDIC (sodium dichloroisocyanurate), calcium hypochlorite, chlorine dioxide, didecyl dimethyl ammonium chloride, decyl dimethyl octyl ammonium chloride, and alkyl(C12-16) dimethylbenzylammonium chloride. Granular bleach may be contained within at least one water-permeable polymer cloth packages (shown in drawing FIGS. 5 and 6). Alternatively, solid bleach may be molded in block form in a shape that fits within the grill cover 201 (shown in FIG. 7). Installation finger tabs 107A and 107B enable an installer to hold the ends of the mounting strip 101 after it is bent into a horseshoe shape and more easily position it beneath the rim of a toilet bowl.

It will be noted, particularly in FIG. 3, that each grill cover 201 has an upper retention tab 301 in the center of the top edge of the grill cover 201, which snaps into an upper retention slot 104 along the upper edge of mounting strip 101. There is also a bottom retention tab located in the center of the bottom edge of the grill cover 201. Though the lower retention tab is not visible, its function is identical to that of the upper retention tab 301. The bottom edge of the mounting strip 101 also has a plurality of lower retention slots (also not shown), which are analogous in function to the upper retention slops 104. It will also be noted that each grill cover 201 has an alignment aperture 302 at each corner thereof. Alignment pegs 202, which are even more visible in the enlarged view of FIG. 4, slide into those alignment apertures 302, thereby allowing the mounting strip 101 to flex. The grill covers 201 are also designed to flex so that they assume the curvature of the toilet bowl in which the cleaner unit 100 is installed. Even when the mounting strip 101 is bent into a horseshoe configuration, the upper retention tab 301 and the lower retention tab maintain the grill cover 201 secured to the mounting strip 101, and the alignment pegs 201, in combination with the alignment apertures 302, maintain proper alignment of the grill cover 201 with the mounting strip 101. Optionally, a fragrance may be added to the bleach compound If desired.

Also, as an alternate embodiment, a deodorant bar 203 incorporating a sublimable aromatic material is suspended at each end of the mounting strip 101 on a resilient clip 204A or 204B that is unitary with the mounting strip 101 and projects from the back side thereof. As the resilient clips 204A and 204B are longer than the bars 202 are thick, they act as a standoffs to space the deodorant bars 203 away from the side of the toilet bowl so that a greater surface area of the deodorant bar 203 is exposed to air in the toilet bowl.

Referring now to FIG. 4, as a means of reducing manufacturing cost of the item, the mounting strip 101 may be made in two equal-length pieces 101A and 101B, which lock together to form a single mounting strip 101. An upper barbed tab 401U on piece 101B passes through an upper retention slot 402U and snaps over an upper retention shelf 403U on piece 101A, and a lower barbed tab 401L passes through a lower retention slot 402L and snaps over a lower retention shelf 403L on piece 101A.

Likewise, an upper barbed tab 404U on piece 101A passes through an upper retention slot 405U and snaps over an upper retention shelf 406U on piece 101A, and a lower barbed tab 404L passes through a lower retention slot 405L and snaps over a lower retention shelf 406L on piece 101A. In order to joint the two equal-length pieces 101A and 101B, they are joined in a folded configuration so that the back side 102B of each piece 101A or 101B makes about a right angle with the other piece. They are then unfolded to a straight configuration and the barbed tabs 401U, 401L, 404U, and 404L virtually simultaneously snap over their respective retention shelves 403U, 403L, 406U, and 406L. The deodorant bars 203 continually dispense an odor-counteracting aroma.

With each flush of the toilet, the bleach inside the grill covers 201—whether in granular or block form—is partially dissolved, thereby dispensing a controlled amount of the chemical compound, which interferes with the formation of hard water deposits and urine calculus deposits that would otherwise form within the toilet bowl. The weak acid supplies behind the cover grills 201 and the deodorant bars 203 are designed to last for about 30 days. At the end of this period, the unit is removed, discarded, and replaced with a fresh unit. The mounting strip 101 may incorporate a hook 105 and loop 106 at opposite ends thereof so that an entire multi-function cleaner and deodorizer unit 100 having expended bleach and deodorant supplies may be discarded as a hoop that fits within canister-type garbage containers.

Referring now to FIGS. 5 and 6, bleach granules are enclosed in a water-permeable polymer cloth package 500. At least one such package 500 is installed beneath each cover grill 201. The polymer cloth is made from mildew resistant fibers made from a polymer such as nylon, polypropylene, polyethylene, acrylic, acetate, polyester, or other similar polymers or copolymers which are equivalent for the application. The cloth can be sewn or heat seamed at line 501 to form the package 500. One end of the package 500 can remain unseamed or unsewn while filling. After filling the end can be seamed or sewn.

Referring now to FIG. 7, a block of solid bleach 700, molded to fit beneath a cover grill 201, is shown.

Referring now to FIG. 8, the cleaner unit 100 is shown installed beneath the rim 801 of bowl 802 of a toilet 800. Because this is a cross-sectional view, only one half of the unit 100 is visible. The loop 106 on piece 101B is visible in this view, as are barbed hooks 404U and 404L, installation finger tab 107A, and a single cover grill 201-D.

In addition to the embodiments of the invention that have been shown and described, it will be obvious to those having ordinary skill in the art that changes may be made thereto without departing from the scope and spirit of the invention as claimed. For example, other cleaning agents besides bleach may be used in connection with the cleaning device described herein. Examples of other cleaning agents are, without limitation, as follow: sulfamic acid, sodium hypochlorite (NaClO), sodium perborate, sodium percarbonate, benzoyl peroxide, bromates, peracetic acid, tetrasodium (EDTA), sodium dodecylbenzenesulfonate, and sodium dichloroisocyanurate.

What is claimed is:

1. A toilet bowl cleaning unit disposed to intercept an intermittent flow of water from each flush of water from a water line to a toilet bowl comprising:
a mounting device for installation in the flow of water, and
a water-soluble compound positioned on the mounting device to intercept a substantial portion of the water as it is flushed from the water line to the toilet bowl, said water-soluble compound thereby being released into the toilet bowl with the water from each flush to inhibit formation of mineral deposits on the surfaces of the toilet bowl and/or drainage pipes.

2. The toilet bowl cleaning unit of claim 1, wherein the mounting device comprises a generally linear, resilient mounting strip having a front side and a back side, said mounting strip being bendable into a horseshoe-shape configuration for installation beneath the rim of a toilet bowl with said back side facing the bowl.

3. The toilet bowl cleaning unit of claim 2, wherein said mounting strip is bent to store mechanical energy therein when bent, said stored energy acting to exert a radial force which maintains the mounting strip in place against the toilet bowl.

4. The toilet bowl cleaning unit of claim 2, wherein the water-soluble compound comprises an exposed, water-soluble compound positioned against the back side of said mounting strip, a dissolved portion of said compound being released into the toilet bowl with water from each flush to inhibit formation of mineral deposits on the surfaces of the toilet bowl and drainage pipes.

5. The toilet bowl cleaning unit of claim 1, wherein the water-soluble compound is a bleach compound.

6. The toilet bowl cleaning unit of claim 5, wherein the bleach compound comprises at least one of the following group of bleach compounds: hydrogen peroxide (H₂O₂), trichloroisocyanuric acid (TCIC), sodium dichloroisocyanurate (SDIC), calcium hypochlorite, chlorine dioxide, didecyl dimethyl ammonium chloride, decyl dimethyl octyl ammonium chloride, and alkyl(C12-16)dimethylbenzylammonium chloride.

7. The toilet bowl cleaning unit of claim 1, wherein the water-soluble compound comprises at least one of the following group of compounds: bleach, sulfamic acid, sodium hypochlorite (NaClO), sodium perborate, sodium percarbonate, benzoyl peroxide, bromates, peracetic acid, tetrasodium (EDTA), sodium dodecylbenzenesulfonate, sodium dodecylbenzenesulfonate, and sodium dichloroisocyanurate.

8. A method for cleaning a toilet bowl, comprising:
providing an intermittent flow of water from a water line to a toilet bowl with each flush of the toilet bowl, and
providing a water-soluble compound to intercept a substantial portion of the flow of water, said water-soluble compound thereby being released into the toilet bowl with the water from each flush to inhibit formation of mineral deposits on the surfaces of the toilet bowl and/or drainage pipes.

9. The method for cleaning a toilet bowl of claim 8, comprising positioning the water-soluble compound on a mounting device disposed to intercept the substantial portion of the water flow.

10. The method for cleaning a toilet bowl of claim 9, comprising positioning the water-soluble compound around a substantial portion of a rim of the toilet bowl to intercept the flow of water coming from the water line into the toilet bowl by way of the rim.

11. The method for cleaning a toilet bowl of claim 8, wherein the water-soluble compound comprises a water-soluble bleach compound.

12. The method for cleaning a toilet bowl of claim 11, wherein the water-soluble bleach compound comprises at least one bleach compound from the following group of bleach compounds: hydrogen peroxide (H₂O₂), trichloroisocyanuric acid (TCIC), sodium dichloroisocyanurate (SDIC), calcium hypochlorite, chlorine dioxide, didecyl dimethyl ammonium chloride, decyl dimethyl octyl ammonium chloride, and alkyl(C12-16)dimethylbenzylammonium chloride.

13. The method for cleaning a toilet bowl of claim 8, wherein the water-soluble compound comprises at least one compound from the following group of compounds: bleach, sulfamic acid, sodium hypochlorite (NaClO), sodium perborate, sodium percarbonate, benzoyl peroxide, bromates, peracetic acid, tetrasodium (EDTA), sodium dodecylbenzenesulfonate, sodium dodecylbenzenesulfonate, and sodium dichloroisocyanurate.

14. A toilet bowl cleaner unit installable under the rim of a toilet bowl comprising:
a generally linear, resilient mounting strip having a front side and a back side, said mounting strip being bendable into a horseshoe-shape configuration for installation beneath the rim of a toilet bowl with said back side facing the bowl, said mounting strip storing energy therein when bent, said stored energy acting to exert a radial force which maintains the mounting strip in place against the toilet bowl; and
an exposed, water-soluble compound positioned against the back side of said mounting strip, a dissolved portion of said compound being released into the toilet bowl with water from each flush to inhibit formation of mineral deposits on the surfaces of the toilet bowl and drainage pipes.

15. The cleaner unit of claim 14, further including at least one deodorant bar attached to the backside of said mounting strip, said deodorant bar continually dispensing an odor-counteracting aroma.

16. The cleaner unit of claim 14, wherein said water-soluble compound is in granular form and enclosed in a plurality of packets made of water-permeable cloth made of synthetic polymer fibers.

17. The cleaner unit of claim 14, wherein said water-soluble compound is in block form.

18. The cleaner unit of claim 14, wherein said water-soluble compound is enclosed behind cover grills which snap onto said mounting strip.

19. The cleaner unit of claim 14, wherein said water-soluble compound is bleach.

20. The cleaner unit of claim 17, wherein the synthetic polymer fibers are selected from the group consisting of nylon, polypropylene, polyethylene, acrylic, acetate, and polyester.

21. The cleaner unit of claim 19, wherein each cover grill has upper and lower snap tabs positioned between outer ends which secure the cover grill to the mounting strip and an alignment aperture positioned at each outer corner of the cover grill, each alignment aperture sliding over an alignment peg which protrudes from the mounting strip, said apertures and alignment pegs enabling the mounting strip to pull away from the outer ends of each cover grill when the mounting strip is bent into the horseshoe-shape configuration.

22. The cleaner unit of claim 15, wherein each deodorant bar is mounted on a resilient clip thatis unitary with the mounting strip and projects from the back side thereof, said resilient clip being longer than the bar is thick, such that it acts as a standoff to space the deodorant bar away from the side of the toilet bowl so that a greater surface area of the deodorant bar is exposed to air in the toilet bowl.

23. The cleaner unit of claim 14, wherein said mounting strip has a gentle upward curve so that when the mounting strip is bent in the horseshoe-shape configuration and the strip is installed beneath the rim of a toilet bowl, a lower edge of the mounting strip is angled toward the bowl.

24. The cleaner unit of claim 14, wherein said mounting strip is fabricated in two generally equal-length portions that can be joined together using a system of hooked tabs and slots.

25. The cleaner unit of claim 14, wherein said mounting strip has a hook at one end and loop at the other end so that the ends can be hooked together and the unit discarded, when expended, in a generally circular configuration that fits in conventional canister-type garbage cans.

26. A disposable cleaner unit installable under the rim of a toilet bowl comprising:
a generally linear, resilient mounting strip having a front side and a back side, said mounting strip being bendable into a horseshoe-shape configuration for installation beneath the rim of a toilet bowl with said back side facing the bowl, said mounting strip storing energy therein when bent, said stored energy acting to exert a radial force against the toilet bowl which maintains the mounting strip in place; and
multiple supplies of an exposed, bleach in solid form secured to the back side of said mounting strip along a major portion of its length, a dissolved portion of said compound being released into the toilet bowl with water from each flush to inhibit formation of mineral deposits on the surfaces of the toilet bowl and drainage pipes.

27. The disposable cleaner unit of claim 26 further comprising at least one deodorant bar secured to the backside of said mounting strip, said deodorant bar incorporating a sublimable compound that continually dispenses an aroma which masks odors.

28. The disposable cleaner unit of claim 26, wherein said bleach in solid form is bleach.

29. The disposable cleaner unit of claim 26, wherein said bleach in solid form is stored behind a plurality of grill covers which is attached to said resilient mounting strip.

30. The disposable cleaner of claim 29, wherein each grill cover has upper and lower snap tabs positioned between outer ends of the container, said snap tabs securing the container to said mounting strip, each of said grill cover also having an alignment aperture positioned at each outer corner thereof, each alignment aperture sliding over an alignment peg which protrudes from the mounting strip, said apertures and alignment pegs enabling the mounting strip to pull away from the outer ends of each container when the mounting strip is bent into the horseshoe-shape configuration.

31. The disposable cleaner unit of claim 26 wherein each deodorant bar is mounted on a resilient clip that is unitary with the mounting strip and projects from the back side thereof, said resilient clip being longer than the bar is thick, such that it acts as a standoff to space the deodorant bar away from the side of the toilet bowl so that a greater surface area of the deodorant bar is exposed to air in the toilet bowl.

32. The cleaner unit of claim 26, wherein said mounting strip has a gentle upward curve so that when the mounting strip is bent in the horseshoe-shape configuration and the strip is installed beneath the rim of a toilet bowl, a lower edge of the mounting strip is angled toward the bowl.

33. The cleaner unit of claim 26, wherein said mounting strip is fabricated in two generally equal-length portions that can be joined together using a system of hooked tabs and slots.

34. The cleaner unit of claim 26, wherein said mounting strip has a hook at one end and loop at the other end so that the ends can be hooked together and the unit discarded, when expended, in a generally circular configuration that fits in conventional canister-type garbage cans.

35. The cleaner unit of claim 29, wherein said supplies of bleach in solid form are selected from the group consisting of granules of the bleach contained within a water-permeable cloth bag and blocks of the bleach.
